(19) United States
(12) Patent Application Publication
(10) Pub. No.: US 2025/0253517 A1
(43) Pub. Date: Aug. 7, 2025

(54) HOUSING FOR AN ANTENNA AND ANTENNA DEVICE

(71) Applicant: Huawei Technologies Co., Ltd., Shenzhen (CN)

(72) Inventors: Tekin Ölmez, Munich (DE); Christian Helbig, Munich (DE); Dieter Zierhut, Munich (DE); Johann Baptist Obermaier, Munich (DE); Bernhard Rist, Munich (DE); Liansong Wang, Dongguan (CN); Serban Rebegea, Munich (DE); Sebastian Ilsanker, Munich (DE)

(21) Appl. No.: 19/189,818

(22) Filed: Apr. 25, 2025

Related U.S. Application Data
(63) Continuation of application No. PCT/EP2022/080043, filed on Oct. 27, 2022.

(51) Int. Cl. H01Q 1/00; H01Q 1/38; H01Q 1/42

(52) U.S. Cl. CPC H01Q 1/002; H01Q 1/38; H01Q 1/422

(57) ABSTRACT

The present disclosure relates to a housing for an antenna. The housing has a wall that includes a first layer and a second layer. One of the first layer and the second layer is an outer layer of the wall and another one of the first layer and the second layer is an inner layer of the wall. The first layer and the second layer are at least partly in contact with each other. The first layer is deformable by an impact on the wall and is thicker than the second layer.

### CROSS-REFERENCE TO RELATED APPLICATIONS

This application is a continuation of International Application No. PCT/EP2022/080043, filed on Oct. 27, 2022, the disclosure of which is hereby incorporated by reference in its entirety.

### TECHNICAL FIELD

The present disclosure relates to a housing for an antenna and to an antenna device.

### BACKGROUND

A housing for an antenna is used for protecting the antenna and optionally corresponding electronic parts (e.g. for operating the antenna) against an environment in which the antenna is arranged, i.e. against outside influence and harm. For this the antenna and optionally the corresponding electronic parts may be at least partly arranged inside the housing. A housing for an antenna may be referred to as an antenna housing. The terms “case” and “enclosure” may be used as synonyms for the term “housing”.

### SUMMARY

For implementing a housing for an antenna a glass fiber reinforced housing may be used, i.e. a housing that is made of a fiber reinforced material. The glass fiber reinforced housing may act as a shield against impacts from outside (e.g. weather conditions, such as rain, hail, snow etc.) and lead surface loads, such as wind load into antenna brackets and a mast, when the housing is installed at the antenna brackets and the mast. Glass fiber reinforced housing are very heavy due to the fiber reinforced material of the housing.

In view of the above, this disclosure aims to improve a housing for an antenna. Embodiments of this disclosure improve a weight of a housing for an antenna. Advantageous implementations are further defined in the dependent claims.

A first aspect of this disclosure provides a housing for an antenna. The housing comprises a wall. The wall comprises a first layer and a second layer. One of the first layer and the second layer is an outer layer of the wall and another one of the first layer and the second layer is an inner layer of the wall. The first layer and the second layer are at least partly in contact with each other. The first layer is elastically or plastically deformable by an impact on the wall and is thicker than the second layer.

A “layer” may be an elementary layer, or it may be a composite layer. An elementary layer has got a uniform structure, whereas a composite layer has got a layered structure. In other words, a composite layer comprises two or more layers that are layered atop each other.

The inner layer is an “inner” layer and the outer layer is an “outer” layer in the sense that the inner layer is arranged closer to an inside (i.e. inner volume) of the housing than the outer layer. The outer layer is arranged closer to an outside (i.e. environment) of the housing. In other words, the outer layer comes after the inner layer on a propagation path of a radio-frequency wave generated inside the housing. The wall may comprise one or more further inner layers. In this case, the above-mentioned inner layer may or may not be the innermost layer of the wall. The wall may comprise one or more further outer layers. In this case, the above-mentioned outer layer may or may not be the outermost layer of the wall.

Since the first layer and second layer are at least partly in contact and the first layer is thicker than the second layer, the first layer is configured to absorb at least part of the energy of the impact and, thus, prevent the second layer from being destroyed by the energy of the impact. In other words, the wall of the housing and, thus, the layers of the wall are configured to absorb the energy of the impact on the wall such that the second layer is not destroyed by the energy of the impact. The terms “destruct” and “destroy” may be used as synonyms.

Therefore, the housing of the first aspect may provide the same function as a fiber reinforced housing (i.e. protection against impacts from outside the housing) without the need of using fiber reinforced material for implementing the housing. Thus, the housing of the first aspect is improved with regard to weight compared to a fiber reinforced housing, such as a glass fiber reinforced housing. Namely, it is the combination of the first layer and the second layer that provides the same characteristic as the fiber reinforced material allowing absorption of energy of an impact on the wall and, thus, a protection against environmental influences by the second layer that is not destroyed by the impact due to the absorption of the impact's energy by the first layer and the second layer.

Since it is the combination of the first layer and the second layer that allows absorption of energy of an impact on the wall, less material is used by the housing according to the first aspect of this disclosure compared to a housing made of fiber reinforced material. This leads to a better transparency for radiation of radio-frequency waves (RF waves) from or to an antenna arranged inside the housing (i.e. from inside to outside the housing and vice versa) and, thus, to a better performance of the antenna.

Since the first layer is thicker than the second layer and the first layer and the second layer are at least partly in contact with each other, an impact on the wall is absorbed by the wall such that the first layer absorbs at least a part of the energy of the impact to prevent the second layer from being destroyed. Thus, the first layer and the second layer are implemented such the second layer is at most plastically deformed by an impact on the wall. The first layer and the second layer may be implemented such that the first layer may absorb more energy of an impact on the wall compared to the second layer to prevent the second layer from being destroyed (e.g. at least partly destroyed) by the impact.

Optionally, the first layer may have a rib structure (e.g. brittle rib structure). For example, the rib structure may comprise 3 mm thick ribs (e.g. 3 mm×3 mm thick ribs) optionally with 15 mm thick holes. In this case, the second layer may be 0,5 mm thick, e.g. a 0.5 mm thick foil. Optionally, the first layer may have a carrier structure (e.g. brittle carrier structure). For example, the carrier structure may be 2 mm thick. In this case, the second layer may be 0.5 mm thick, e.g. a 0.5 mm thick foil.

The thickness of the layers, e.g. the first layer and second layer, of the wall of the housing may be designed to achieve a compromise between deflection destruction and deceleration of the impact on the wall (e.g. of an object causing the impact on the wall). That is, the first layer may be thicker by a degree or extent compared to the second layer that depends on a compromise between deflection destruction and deceleration of the impact on the wall (e.g. an object causing the impact on the wall).

In case of an impact on the wall, the first layer may be configured to be elastically deformed by the impact, plastically deformed by the impact or at least partly destroyed by the impact in order to be able to absorb such an amount of energy of the impact on the wall that the second layer is not destroyed by the impact on the wall and remains intact, i.e. that the second layer keeps its protecting function for protecting the inside of the housing against the environment outside the housing.

The layers of the wall are transparent for radio-frequency (RF) signals at least in a certain range of the spectrum. Electromagnetic waves in that frequency range, which are transmitted by an antenna that may be arranged inside the housing, can thus pass through the wall. Similarly, an incident electromagnetic wave in that frequency range can travel through the wall and reach an antenna that may be arranged inside the housing.

The first layer may be configured to be elastically deformable, plastically deformable or at least partially destroyable by an impact on the wall and, thus, absorb at least part of the energy of the impact.

The wall of the housing may be referred to as a crumble zone. In other words, the layers of the wall are arranged to form a crumble zone (for absorbing the energy of the impact). The layers of the wall, e.g. the first and second layer, may be configured to act as a crumble zone.

The second layer being the outer layer may be configured to divide or spread the energy of the impact (i.e. the stress) on the wall across the first layer being the inner layer. The second layer may be at least partly layered on the first layer.

The housing may be a radome. The housing may be a shell. The first layer may be referred to as “support layer”.

The impact may be due to weather (e.g. in the form of precipitation, such as rain, hail, snow etc.), solid elements (e.g. dust, stones etc.) etc.

The first layer may have an intended breaking point in order to absorb energy of an impact on the wall and protect the second layer from being destroyed by the impact.

In an implementation form of the first aspect, the second layer is weatherproof, waterproof, lightproof, and/or dustproof.

The second layer can thus protect anything located on its inner side (especially the antenna, or any layers arranged further inward than the second layer) against effects from outside, such as water (e.g. rain, hail, humidity), sunlight, and/or dust. The second layer may in this case be referred to as a sealing layer.

In one embodiment, the first layer is the inner layer of the wall, and the second layer is the outer layer of the wall. The second layer can thus serve to protect the first layer against outside effects such as rain, hail, or sunlight.

In an implementation form of the first aspect, the first layer is more brittle than the second layer.

The first layer may be less elastic than the second layer. The first layer may have a greater Young's modulus compared to the second layer. Alternatively, the first layer may have a smaller Young's modulus compared to the second layer, e.g. in case the first layer has a foam structure, such as a brittle foam structure. The first layer may have a smaller Young's modulus compared to the second layer, but due to the greater thickness compared to the second layer (the first layer may be several times thicker, e.g. at least three times thicker, than the second layer), the first layer may have a greater section modulus compared to the second layer. In the aforementioned case, the first layer may have a brittle foam structure.

This supports the wall of the housing in absorbing energy of an impact on the wall so that the second layer is not destroyed due to the impact.

In an implementation form of the first aspect, the first layer has a greater stiffness compared to the second layer.

This supports the wall of the housing in absorbing energy of an impact on the wall so that the second layer is not destroyed due to the impact.

In an implementation form of the first aspect, the first layer is at least three times thicker than the second layer.

This supports the wall of the housing in absorbing energy of an impact on the wall so that the second layer is not destroyed due to the impact.

In an implementation form of the first aspect, the first layer has a greater section modulus compared to the second layer.

This supports the wall of the housing in absorbing energy of an impact on the wall so that the second layer is not destroyed due to the impact.

In an implementation form of the first aspect, the second layer is made of a plastic material that is not fiber reinforced.

This improves (i.e. reduces) the weight of the housing, for example compared to a fiber reinforced housing.

The second layer may be made of a plastic material that is not glass fiber reinforced. The second layer may be a plastic foil that is not fiber reinforced (optionally not glass fiber reinforced). In other words, the second layer may not be fiber-reinforced (e.g. not glass-fiber-reinforce). That is, the second layer may be made of a non-fiber-reinforced plastic material (e.g. non-glass-fiber-reinforced plastic material).

In an implementation form of the first aspect, the second layer is made of at least one of PET, PA, POM, PBT, ABS, PS, PI and PVC.

This improves the weight of the housing, for example compared to a fiber reinforced housing, and at the same provides a protection layer against environmental influences from outside the housing.

The abbreviation “PET” stands for “polyethylene terephthalate”. The abbreviation “PA” stands for “polyamide”. The abbreviation “POM” stands for “polyoxymethylene”. The abbreviation “PBT” stands for “polybutylene terephthalate”. The abbreviation “ABS” stands for “acrylonitrile butadiene styrene”. The abbreviation “PS” stands for “polystyrene”. The abbreviation “PI” stands for “polyimide”. The abbreviation “PVC” stands for “polyvinyl chloride”. In addition or alternatively, the second layer may be made of one or more other known plastic material types.

That is, the second layer may be made of plastic material. The terms “synthetic polymer material” or “polymer material” may be used as synonyms for the term “plastic material”. The second layer may be made of two or more different types of plastic material.

The second layer may be a plastic foil. The second layer may be at least one of a PET foil, PA foil, POM foil, PBT foil, ABS foil, PS foil, PI foil and PVC foil.

In an implementation form of the first aspect, the first layer has a lattice structure.

This supports the wall of the housing in absorbing energy of an impact on the wall so that the second layer is not destroyed due to the impact.

In an implementation form of the first aspect, the first layer is made of a fiber reinforced plastic material.

Since only a part of the wall of the housing, e.g. the first layer, may be made of the fiber reinforced plastic material, the weight of housing may be improved (i.e. reduced) compared to a fiber reinforced housing, i.e. a housing made of fiber reinforced material. At the same time, the optional fiber reinforced material of the first layer supports the wall in absorbing energy of an impact on the wall.

The first layer may be made of a glass fiber reinforced plastic material. The fiber of the reinforced plastic material may be glass fiber and/or any other known fiber type (e.g. carbon fiber). For example, the first layer may made of a glass fiber and/or carbon fiber reinforced plastic material.

In an implementation form of the first aspect, the first layer is made of at least one of PET GF40, PA GF40, POM GF40, PBT GF40, ABS GF40, PS GF40, PI GF40 and PVC GF40.

Since only a part of the wall of the housing, e.g. the first layer, may be made of the fiber reinforced plastic material, the weight of housing may be improved (i.e. reduced) compared to a fiber reinforced housing, i.e. a housing made of fiber reinforced material. At the same time, the optional fiber reinforced material of the first layer supports the wall in absorbing energy of an impact on the wall.

The abbreviation “GF 40” may mean that the respective fiber-reinforced material comprises 40% of glass fiber. Optionally, percentage values are to be understood as weight percentages. The first layer may be made of a fiber reinforced plastic material that comprises between 10% and 70%, optionally 10% and 50% fiber material, such as glass fiber.

In an implementation form of the first aspect, the first layer has a foam structure.

This supports the wall of the housing in absorbing energy of an impact on the wall so that the second layer is not destroyed due to the impact and at the same time improves (i.e. reduces) the weight of the housing, for example compared to a fiber reinforced housing.

The foam structure may be a PET foam structure or any other known plastic material foam structure. The foam structure may be a brittle foam structure.

In an implementation form of the first aspect, the layers of the wall are configured such that they each are at most elastically deformable in case the impact on the wall causes a pressure less than or equal to 3 kPa.

In other words, the layers of the wall may be made or implemented such that environmental influences on the wall causing a pressure less than or equal to 3 kPA do not result in a plastically deformation and/or at least partly destruction of any one of the layers of the wall. That is, the layers of the wall may be made or implemented such that at most each of the layers of the wall are elastically deformed in case of environmental influences on the wall cause a pressure less than or equal to 3 kPa. In other words, the wall of the housing (i.e. the overall system) may allow elastic deformation during a standard stress.

In an implementation form of the first aspect, the wall comprises a third layer. The first layer and the third layer may be at least partly in contact on a side opposite to a side on which the first layer and the second layer are at least partly in contact; and the first layer may be thicker than the third layer.

The description of the second layer is correspondingly valid for the third layer. The third layer may be implemented similarly to the second layer.

The wall of the housing and, thus, the layers of the wall may be configured to absorb the energy of the impact on the wall such that the third layer is not destroyed by the energy of the impact. The third layer may be at least partly layered on the first layer.

In one implementation form, the third layer is the outermost layer of the wall, the first layer is the outer layer of the wall relative to the second layer being the inner layer of the wall. The third layer may be elastically or plastically deformed by an impact and may thus absorb at least part of the energy of the impact. The first layer may absorb the rest of the energy of the impact. This prevents the third layer from being destroyed by the energy of the impact.

The third layer, which is the outermost layer in this implementation form, may be configured to divide or spread the energy of the impact (i.e. the stress) on the wall across the first layer.

The third layer may be weatherproof, waterproof and/or dustproof. The first layer may be more brittle than the third layer. The first layer may be less elastic than the third layer. The first layer may have a greater stiffness compared to the third layer. The first layer may be at least three times thicker than the third layer. The first layer may have a greater section modulus compared to the third layer.

The third layer may be made of a plastic material that is not fiber reinforced. The third layer may be made of a plastic material that is not glass fiber reinforced. The second layer is a plastic foil that is not fiber reinforced (optionally not glass fiber reinforced).

In other words, the third layer may be not fiber-reinforced (e.g. not glass-fiber-reinforce). That is, the second layer may be made of a non-fiber-reinforced plastic material (e.g. non-glass-fiber-reinforced plastic material).

The third layer may be made of at least one of PET, PA, POM, PBT, ABS, PS, PI and PVC. That is, the third layer may be made of plastic material. In addition or alternatively, the second layer may be made of one or more different types of plastic material. The third layer may be a plastic foil. The third layer may be at least one of a PET foil, PA foil, POM foil, PBT foil, ABS foil, PS foil, PI foil and PVC foil.

The third layer may be a backup or auxiliary layer with regard to the second layer. For example, for a rare case that there is an impact on the wall for which the first layer and the second layer are not designed, i.e. the first layer and the second layer together are not able to absorb the energy of the impact such that the second layer is not destroyed by the impact, the third layer may remain intact to provide the protecting function of the second layer. For example, the aforementioned rare case of an impact for which the first layer and the second layer are not designed may be possible in case the housing is used in an area with weather conditions for which the housing is not designed or approved (i.e. ignoring information of the data sheet of the housing) or in case of willful damage to property by a person being performed on the housing. In other words, the third layer may be a backup or auxiliary layer for the second layer in order to provide additional protection against impact beyond the definitions of the data sheet of the housing and/or legislations.

Optionally, the second layer and the third layer may be different to each other with regard to the kind of protection provided by the respective layer. For example, the second layer may be at least one of weatherproof, waterproof and dustproof and the third layer may be at least one other of weatherproof, waterproof and dustproof.

Optionally, in addition or alternatively to the third layer, the wall may comprise a fourth layer that is thicker than the second layer. The fourth layer and the second layer may be at least partly in contact at a side opposite to a side, at which the first layer and the second layer are at least partly in contact. Alternatively, in case the third layer is not present, the fourth layer and the first layer may be at least partly in contact at a side opposite to a side, at which the first layer and the second layer are at least partly in contact. Alternatively, in case the third layer is present, the fourth layer and the third layer may be at least partly in contact at a side opposite to a side, at which the first layer and the third layer are at least partly in contact.

The fourth layer and the first layer may be the same type of layer and, thus, the description of the first layer may be correspondingly valid for the fourth layer. The first layer and the fourth layer may be implemented the same. That is, the fourth layer may be implemented in line with the first layer (e.g. they may have the same thickness etc.). Optionally, the first layer and the fourth layer may have different thickness.

The optional fourth layer may allow the wall to absorb more energy of an impact and, thus, to resist greater impacts compared to the case, where there is only the first layer and the second layer. Since the fourth layer is at least partly in contact with a respective other layer of the wall, the fourth layer may absorb (in addition to the first layer, the second layer and optionally the optional third layer) energy from an impact on the wall and, thus, enable (together with the first layer) that such an amount of energy of the impact on the wall is absorbed that the second layer is not destroyed by the impact on the wall.

Optionally, the layer structure of the first layer and the second layer may be repeated one or more times such that respective two or more layer structures of the first layer and the second layer are at least partly in contact with a corresponding neighboring layer structure of the first layer and the second layer. This allows absorbing more energy compared to the case of the wall comprising the first layer and the second layer without an additional layer. At least two of the optional two or more aforementioned layer structures may be at least partly layered on each other.

At least two of the second layers of the optional two or more aforementioned layer structures may be differently implemented to each other (in line with the description of the second layer of the wall of the housing according to the first aspect of this disclosure). Optionally, at least two of the second layers of the optional two or more aforementioned layer structures may be different to each other with regard to the kind of protection provided by the respective layer. For example, the second layer of one aforementioned layer structure may be at least one of weatherproof, waterproof and dustproof and the second layer of at least one other aforementioned layer structure may be at least one other of weatherproof, waterproof and dustproof. At least two of the first layers of the optional two or more aforementioned layer structures may be differently implemented to each other (in line with the description of the first layer of the wall of the housing according to the first aspect of this disclosure). For example, at least two of the first layers of the optional two or more aforementioned layer structures may have a different thickness.

In an implementation form of the first aspect, the second layer and the third layer are the same type of layer arranged on opposite sides of the first layer.

In order to achieve the housing according to the first aspect of this disclosure, some or all of the implementation forms and optional features of the first aspect, as described above, may be combined with each other.

A second aspect of this disclosure provides an antenna device comprising an antenna and a housing, the antenna being arranged at least partly inside the housing. The housing has a wall that comprises a first layer and a second layer, wherein one of the first layer and the second layer is an outer layer of the wall and another one of the first layer and the second layer is an inner layer of the wall. The first layer and the second layer are at least partly in contact with each other; and the first layer is elastically or plastically deformable by an impact on the wall and is thicker than the second layer.

The description of the housing of the first aspect of this disclosure is correspondingly valid for the antenna device of the second aspect of this disclosure. The description of the housing of the first aspect of this disclosure is correspondingly valid for the housing of the antenna device of the second aspect of this disclosure. The housing of the antenna device of the second aspect may be a housing according to the first aspect of this disclosure, as described above.

The antenna may be a base station antenna. One or more electronic parts for operating the antenna may be at least partly arranged inside the housing.

The antenna device of the second aspect and its implementation forms and optional features achieve the same advantages as the housing of the first aspect and its respective implementation forms and respective optional features.

In order to achieve the antenna device of the second aspect of this disclosure, some or all of the implementation forms and optional features of the second aspect, as described above, may be combined with each other.

All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF THE DRAWINGS

The above described aspects and implementation forms will be explained in the following description of specific embodiments in relation to the enclosed drawings, in which:

FIG. 1 schematically illustrates an example of a wall of a housing for an antenna according to an embodiment of this disclosure, wherein (A) the wall is shown in an unperturbed state, and (B) an object hitting the wall is schematically shown;

FIG. 2 schematically illustrates an example of a part of a wall of a housing for an antenna according to an embodiment of this disclosure, wherein (A) the wall is shown in an unperturbed state, and (B) an object hitting the wall is schematically shown;

FIG. 3 schematically illustrates (A) an example of a housing according to an embodiment of this disclosure for an antenna, and (B) an example of an antenna device according to an embodiment of this disclosure.

In the Figures, corresponding elements are labeled with the same reference sign.

### DETAILED DESCRIPTION OF ILLUSTRATIVE EMBODIMENTS

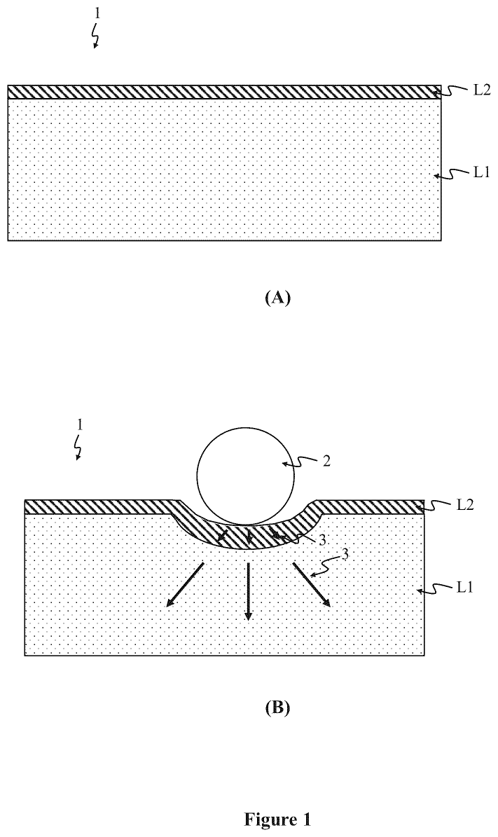

FIG. 1 schematically shows an example of a wall of a housing for an antenna, according to an embodiment of this disclosure. FIG. 1 (A) shows the wall in an unperturbed state. FIG. 1 (B) schematically shows an object (e.g. a ball) hitting the wall. The housing is an example of the housing according to the first aspect of this disclosure. The description of the housing according to the first aspect of this disclosure is correspondingly valid for describing the housing and, thus, the part of the wall of the housing shown in FIG. 1.

As shown in FIG. 1, the wall 1 comprises a first layer L1 and a second layer L2. One of the first layer L1 and the second layer L2 is an outer layer of the wall 1 and another one of the first layer L1 and the second layer L2 is an inner layer of the wall. The first layer L1 and the second layer L2 are at least partly in contact with each other. The first layer L1 is elastically or plastically deformable by an impact 3 on the wall 1 and is thicker than the second layer L2.

In the shown embodiment, the second layer L2 is an outer layer of the wall 1 and the first layer L1 is an inner layer of the wall 1. In an alternative embodiment (not shown), the first layer L1 is an outer layer of the wall 1 and the second layer L2 is an inner layer of the wall 1. Where not indicated otherwise, the present disclosure applies to both of these embodiments.

According to the example of FIG. 1, the second layer L2 is the outermost layer of the wall 1 and the first layer L1 is the innermost layer of the wall 1. Alternatively, the wall 1 may comprise one or more further inner layers (in addition to the first layer L1) and/or one or more further outer layers (in addition to the second layer L2). In the optional case that the wall 1 comprise one or more further inner layers, the first layer L1 may or may not be the innermost layer of the wall 1. In the optional case that the wall 1 comprise one or more further outer layers, the second layer L2 may or may not be the outermost layer of the wall 1.

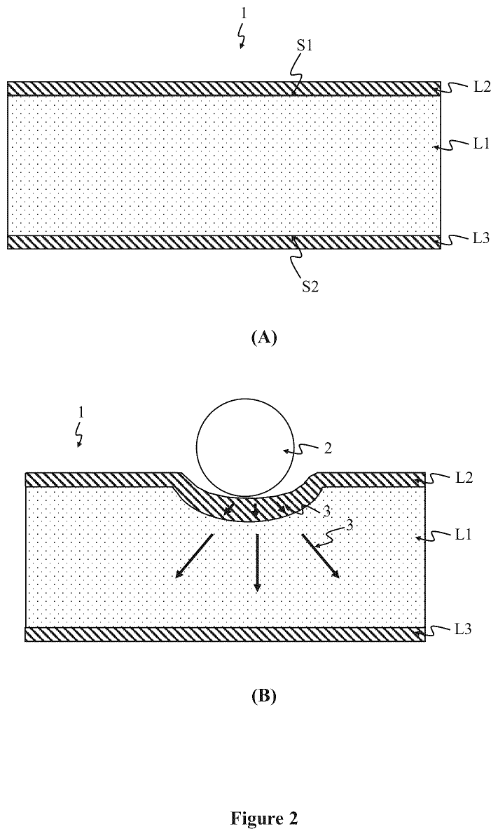

FIG. 2 shows, as an example, the optional case in which there is one further inner layer L3 (referred to as third layer) in addition to the first layer L1 optionally being an inner layer of the wall 1 and the second layer L2 optionally being an outer layer of the wall 1.

The following is true for any one of the layers of the wall 1, i.e. any one of the first layer L1, the second layer L2, optional one or more further inner layers and optional one or more further outer layers: The respective layer may be an elementary layer or a composite layer. An elementary layer has got a uniform structure, whereas a composite layer has got a layered structure. In other words, a composite layer comprises two or more layers that are layered atop each other.

The second layer L2 may be at least partly layered on the first layer L1. According to the example of FIG. 1, the second layer L2 is layered on the first layer L1.

Since the first layer L1 and second layer L2 are at least partly in contact and the first layer L1 is thicker than the second layer L2, the first layer L1 is configured to absorb at least part of the energy of an impact 3 on the wall 1 and, thus, prevent the second layer L2 from being destroyed by the energy of the impact 3. In other words, the wall 1 of the housing and, thus, the layers of the wall 1 are configured to absorb the energy of the impact 3 on the wall 1 such that the second layer L2 is not destroyed by the energy of the impact. As a result, the layer L2 may remain as a barrier for protecting the inside of the housing against the outside of the housing.

For example, the second layer L2 may be at least one of the following: weatherproof, waterproof and dustproof. Therefore, in case of an impact 3 on the wall 1, the second layer L2 may remain intact, i.e. keep its protection function (due to the first layer L1 absorbing at least part of the energy of the impact 3 on the wall 1) and, thus, provide a protection for the inside of the housing against weather, water and/or dust (depending on the type of second layer L2).

For example, the second layer L2 may be weatherproof such that the second layer L2 may provide a barrier against precipitation (e.g. rain, snow, hail etc.). When the second layer L2 is waterproof then the second layer L2 may provide a barrier against water. When the second layer L2 is dustproof then the second layer L2 may provide a barrier against dust. For example, the second layer L2 may provide (i.e. may be implemented or designed to provide) solid particle protection and/or liquid ingress protection according to the ingress protection code (IP code), which is published for example under the technical standard EN 60529 of the European Committee for Electrotechnical Standardization (CENELEC). In addition or alternatively, the second layer L2 may provide (i.e. may be implemented or designed to provide) solid particle protection and/or liquid ingress protection according to any other known technical standard.

Since according to the example of FIG. 1, the second layer L2 is the outermost layer of the wall 1, an impact 3 on the wall 1 is an impact on the second layer L2. As shown in FIG. 1 (B), in case of an impact 3 on the second layer L2 (due to an object 2, e.g. a ball, hitting the second layer L2), the second layer L2 may be elastically or plastically deformable by the impact 3 and, thus, absorb at least part of the energy of the impact 3. The first layer L1 may absorb the rest of the energy of the impact. Since the first layer 1i is thicker than the second layer L2 and the first layer L1 and the second layer L2 are at least partly in contact with each other, the impact 3 on the wall 1 may be absorbed by the wall 1 such that the first layer L1 absorbs at least a part of the energy of the impact to prevent the second layer L2 from being destroyed. Thus, the first layer L1 and the second layer L2 are implemented such that the second layer L2 is at most plastically deformed by an impact on the wall 1. The first layer L1 and the second layer L2 may be implemented such that the first layer L1 may absorb more energy from an impact 3 on the wall 1 compared to the second layer L2 to prevent the second layer L2 from being destroyed (e.g. at least partly destroyed) by the impact.

In case of an impact 3 on the wall 1, the first layer L1 may be configured to be elastically deformable by the impact, plastically deformable by the impact or at least partly destroyed by the impact in order to be able to absorb such an amount of energy of the impact on the wall 1 that the second layer L2 is not destroyed by the impact on the wall 1 and remains intact, i.e. keep its protecting function for protecting the inside of the housing against the environment outside the housing.

The layers of the wall 1 are transparent for radio-frequency (RF) signals at least in a certain range of the spectrum. Electromagnetic waves in that frequency range, which are transmitted by an antenna that may be arranged inside the housing, can thus pass through the wall 1. Similarly, an incident electromagnetic wave in that frequency range can travel through the wall 1 and reach an antenna that may be arranged inside the housing.

The wall 1 of the housing may be referred to as a crumble zone. In other words, the layers of the wall are arranged to form a crumble zone (for absorbing the energy of the impact).

The second layer L2 being the outer layer may be configured to divide or spread the energy of the impact 3 (i.e. the stress) on the wall 1 across the first layer L1 being the inner layer. This is indicated by arrows in FIG. 1 (B), which are labelled with the reference sign “3”.

According to an optional implementation form of the wall 1, the first layer L1 has a lattice structure, is more brittle than the second layer L2 and has a greater stiffness compared to the second layer L2. The first layer L1 may have a rigid structure. The first layer L1 may optionally be made of a fiber reinforced plastic material (e.g. at least one of PET GF40, PA GF40, POM GF40, PBT GF40, ABS GF40, PS GF40, PI GF40 and PVC GF40). The second layer L2 may have an elastic behavior. For example the second layer L2 may be a plastic foil (e.g. at least one of a PET foil, PA foil, POM foil, PBT foil, ABS foil, PS foil, PI foil and PVC foil). The second layer L2 may seal the inside of the housing with regard to outside (i.e. the environment of the housing). The second layer L2 may be configured to divide or spread the energy of the impact (i.e. the stress) on the wall across the lattice structure of the first layer L1. There may be additional optional features or alternative features with regard to the aforementioned optional implementation form for implementing the wall 1.

According to another optional implementation form of the wall 1, the first layer L1 has a foam structure (e.g. PET foam structure), is more brittle than the second layer L2 and has a greater stiffness compared to the second layer L2. The first layer L1 may have a rigid structure. The second layer L2 may have an elastic behavior. For example the second layer L2 may be a plastic foil (e.g. at least one of a PET foil, PA foil, POM foil, PBT foil, ABS foil, PS foil, PI foil and PVC foil). The second layer L2 may seal the inside of the housing with regard to outside (i.e. the environment of the housing). The second layer L2 may be configured to divide or spread the energy of the impact (i.e. the stress) on the wall across the foam structure of the first layer L1. There may be additional optional features or alternative features with regard to the aforementioned optional implementation form for implementing the wall 1.

For further information on the wall 1 of FIG. 1, such as the layers of the wall 1 (e.g. the first layer L1 and/or second layer L2), reference is made to the description of the housing according to the first aspect of this disclosure.

FIG. 2 shows an example of a part of a wall of a housing according to an embodiment of this disclosure for an antenna. FIG. 2 (A) shows a state when there is no impact on the wall and FIG. 2 (B) shows a state when there is an impact on the wall due to an object (e.g. a ball) hitting the wall. The wall of FIG. 2 corresponds to the wall of FIG. 1 with an additional optional feature. Thus, the description of FIG. 1 is correspondingly valid for the wall of FIG. 2 and in the following mainly the additional optional feature of the wall of FIG. 2 is described.

As shown in FIG. 2, the wall 1 may comprise a third layer. The first layer L1 and the third layer L3 may be at least partly in contact at a side S2 opposite to a side S1, at which the first layer L1 and the second layer L2 are at least partly in contact. The first layer L1 may be thicker than the third layer L3. According to the example of FIG. 2, the second layer L2 and the third layer L3 are the same type of layer and, thus, the description of the second layer L2 is correspondingly valid for the third layer L3. The second layer L2 and the third layer L3 may be implemented the same. That is, the third layer L3 may be implemented in line with the second layer L2 (e.g. they may have the same thickness etc.).

The third layer L3 may be a backup or auxiliary layer with regard to the second layer L2. For example, for a rare case that there is an impact on the wall 1 for which the first layer L1 and the second layer L2 are not designed, i.e. the first layer L1 and the second layer L2 together are not able to absorb the energy of the impact such that the second layer L2 is not destroyed by the impact, the third layer L3 may remain intact to provide the protecting function of the second layer L2. For example, the aforementioned rare case of an impact for which the first layer L1 and the second layer L2 are not designed may be possible in case the housing is used in an area with weather conditions for which the housing is not designed or approved (i.e. ignoring information of the data sheet of the housing) or in case of willful damage to property by a person being performed on the housing. In other words, the third layer L3 may be a backup or auxiliary layer for the second layer L2. This allows providing additional protection against impact beyond the definitions of the data sheet of the housing and/or legislations.

Optionally, the second layer L2 and the third layer L3 may be different to each other with regard to the kind of protection provided by the respective layer. For example, the second layer L2 may be at least one of weatherproof, waterproof and dustproof and the third layer L3 may be at least one other of weatherproof, waterproof and dustproof.

Optionally, in addition or alternatively to the third layer L3, the wall 1 may comprise a fourth layer that is thicker than the second layer L2 (not shown in FIG. 2). The fourth layer and the second layer L2 may be at least partly in contact at a side opposite to a side, at which the first layer L1 and the second layer L2 are at least partly in contact. Alternatively, in case the third layer L3 is absent, the fourth layer and the first layer L1 may be at least partly in contact with each other at a side opposite to a side at which the first layer L1 and the second layer L2 are at least partly in contact with each other. Alternatively, in case the third layer L3 is present, the fourth layer and the third layer L3 may be at least partly in contact at a side opposite to a side at which the first layer L1 and the third layer L3 are at least partly in contact with each other. The fourth layer and the first layer L1 may be the same type of layer and, thus, the description of the first layer L1 may apply also to the fourth layer. The first layer and the fourth layer may be implemented similarly or identically. For example, the fourth layer and the first layer L1 may have the same thickness). Optionally, the first layer L1 and the fourth layer may differ in thickness.

The optional fourth layer may allow the wall 1 to absorb more energy of an impact 3 on the wall 1 and, thus, to resist greater impacts compared to the case, where there is only the first layer L1 and the second layer L2. Since the fourth layer is at least partly in contact with a respective other layer of the wall, the fourth layer may absorb in addition to the first layer, the second layer and optionally the optional third layer L3 energy from an impact on the wall 1 and, thus, to enable (together with the first layer L1) that such an amount of energy of the impact 3 on the wall 1 is absorbed that the second layer L2 is not destroyed by the impact on the wall.

Optionally, in addition to the example of FIG. 1, the layer structure of the first layer L1 and the second layer L2 may be repeated one or more times such that respective two or more layer structures of the first layer L1 and the second layer L2 are at least partly in contact with a corresponding neighboring layer structure of the first layer L1 and the second layer L2 (not shown in FIGS. 1 and 2). This allows absorbing more energy compared to the case of the wall 1 comprising the first layer L1 and the second layer L2 without an additional layer.

At least two of the second layers L2 of the optional two or more aforementioned layer structures may be differently implemented to each other (in line with the description of the second layer of the wall of the housing according to the first aspect of this disclosure). Optionally, at least two of the second layers L2 of the optional two or more aforementioned layer structures may be different to each other with regard to the kind of protection provided by the respective layer. For example, the second layer L2 of one aforementioned layer structure may be at least one of weatherproof, waterproof and dustproof and the second layer L2 of at least one other aforementioned layer structure may be at least one other of weatherproof, waterproof and dustproof. At least two of the first layers L1 of the optional two or more aforementioned layer structures may be differently implemented to each other (in line with the description of the first layer of the wall of the housing according to the first aspect of this disclosure). For example, at least two of the first layers L1 of the optional two or more aforementioned layer structures may have a different thickness.

For further information on the wall 1 of FIG. 2, such as the layers of the wall 1 (e.g. the first layer L1, second layer L2, optional third layer L3 and optionally the fourth layer, which is not shown in FIG. 2), reference is made to the description of the housing according to the first aspect of this disclosure.

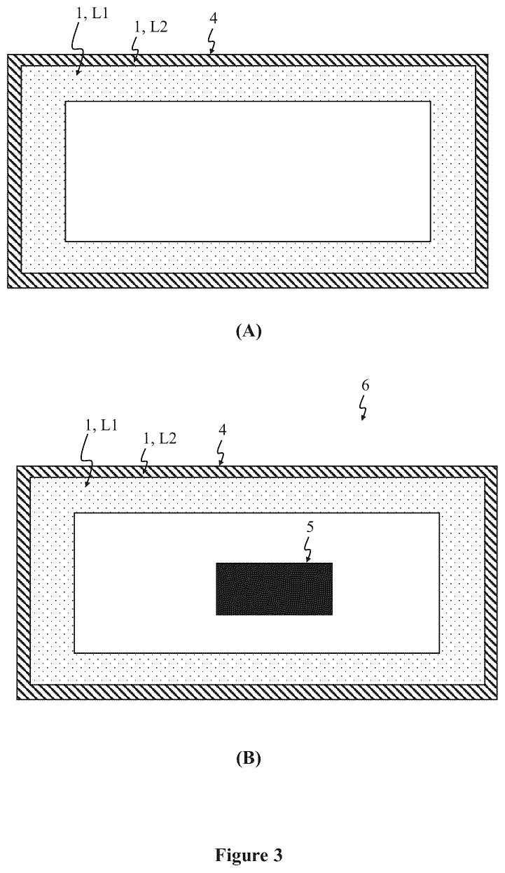

FIG. 3 (A) shows an example of a housing according to an embodiment of this disclosure for an antenna. The housing of FIG. 3 (A) is an example of the housing according to the first aspect of this disclosure. The description of the housing according to the first aspect of this disclosure is correspondingly valid for the housing of FIG. 3 (A). FIG. 3 (B) shows an example of an antenna device according to an embodiment of this disclosure. The antenna device of FIG. 3 (B) is an example of the antenna device according to the second aspect of this disclosure. The description of the antenna device according to the second aspect of this disclosure is correspondingly valid for the antenna device of FIG. 3 (B). The housing of the antenna device of FIG. 3 (B) is an example of the housing according to the first aspect of this disclosure. The description of the housing according to the first aspect of this disclosure is correspondingly valid for the housing of FIG. 3 (B).

As shown in FIG. 3 (A), the housing 4 for an antenna has a wall 1 that comprises a first layer L1 and a second layer L2. According to the example of FIG. 3 (A), the wall 1 of the housing 4 is implemented in line with FIG. 1, wherein the first layer L1 is an inner layer of the wall 1 and the second layer L2 is an outer layer of the wall 1. That is, the wall 1 of the housing 4 of FIG. 3 (A) is the wall 1 of FIG. 1. This is only by way of example and, thus, the wall 1 of the housing 4 of FIG. 3 (A) may be implemented differently, as described with regard to FIGS. 1 and 2.

According to FIG. 3 (A), the housing 4 is completely made of the wall 1. Alternatively, only a part of the housing 4 may be made of or comprise the wall 1 comprising the first layer L1 and the second layer L2. In other words, the housing 4 may comprise the wall 1 of FIGS. 1 and 2 and in addition one or more other types of a wall.

For further information on the housing 4 of FIG. 3 (A) reference is made to the description of the housing according to the first aspect of this disclosure and the description of FIGS. 1 and 2.

As shown in FIG. 3 (B), the antenna device 6 comprises an antenna 5 and a housing 4. The antenna 5 is arranged at least partly inside the housing 4. According to FIG. 3 (B), the antenna is arranged fully inside the housing 4, which is only by way of example. That is, one or more parts of the antenna may be arranged outside the housing 4 (e.g. on the outside surface of the housing 4) or protrude from inside to outside the housing 4. The housing 4 of the antenna device 6 of FIG. 3 (B) is the housing of FIG. 3 (A).

For further information on the antenna device 6 of FIG. 3 (B) reference is made to the description of the antenna device according to the second aspect of this disclosure and the description of FIG. 3 (A).

In the present disclosure the terms “first”, second ”, “third”, “fourth” etc. may be used for merely distinguishing different elements from each other. That is, for example the term “fourth” in front of an element does not necessarily mean that there are four such elements (i.e. first, second, third and fourth element), although this may optionally be the case.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A housing for an antenna, the housing comprising:
a wall, the wall comprising a first layer and a second layer, wherein one of the first layer and the second layer is an outer layer of the wall and another one of the first layer and the second layer is an inner layer of the wall; the first layer and the second layer are at least partly in contact with each other; and the first layer is elastically or plastically deformable by an impact on the wall and is thicker than the second layer.

2. The housing according to claim 1, wherein the second layer is weatherproof, waterproof, or dustproof.

3. The housing according to claim 2, wherein the second layer is weatherproof, waterproof, and dustproof.

4. The housing according to claim 1, wherein the first layer is more brittle than the second layer.

5. The housing according to claim 1, wherein the first layer has a greater stiffness compared to the second layer.

6. The housing according to claim 1, wherein the first layer is at least three times thicker than the second layer.

7. The housing according to claim 1, wherein the first layer has a greater section modulus compared to the second layer.

8. The housing according to claim 1, wherein the second layer is made of a plastic material that is not fiber reinforced.

9. The housing according to claim 1, wherein the second layer is made of at least one of PET, PA, POM, PBT, ABS, PS, PI and PVC.

10. The housing according to claim 1, wherein the first layer has a lattice structure.

11. The housing according to claim 1, wherein the first layer is made of a fiber reinforced plastic material.

12. The housing according to claim 1, wherein the first layer is made of at least one of PET GF40, PA GF40, POM GF40, PBT GF40, ABS GF40, PS GF40, PI GF40 and PVC GF40.

13. The housing according to claim 1, wherein the first layer has a foam structure.

14. The housing according to claim 1, wherein the layers of the wall are configured such that they each are at most elastically deformable in case the impact on the wall causes a pressure less than or equal to 3 kPa.

15. A housing for an antenna, the housing comprising:
a wall, the wall comprising a first layer, a second layer, and a third layer, wherein one of the first layer and the second layer is an outer layer of the wall and another one of the first layer and the second layer is an inner layer of the wall; the first layer and the second layer are at least partly in contact with each other; and the first layer is elastically or plastically deformable by an impact on the wall and is thicker than the second layer, the first layer and the third layer are at least partly in contact at a second side opposite to a first side at which the first layer and the second layer are at least partly in contact; and the first layer is thicker than the third layer.

16. The housing according to claim 15, wherein the second layer and the third layer are the same type of layer arranged on opposite sides of the first layer.

17. The housing according to claim 15, wherein the first layer is made of a fiber reinforced plastic material, and wherein the second layer is made of a plastic material that is not fiber reinforced.

18. An antenna device comprising:
an antenna; and
a housing, the antenna being arranged at least partly inside the housing, and the housing having a wall that comprises a first layer and a second layer, wherein one of the first layer and the second layer is an outer layer of the wall and another one of the first layer and the second layer is an inner layer of the wall; the first layer and the second layer are at least partly in contact with each other; and the first layer is elastically or plastically deformable by an impact on the wall and is thicker than the second layer.

19. The antenna device according to claim 18, wherein the wall comprises a third layer; the first layer and the third layer are at least partly in contact at a second side opposite to a first side, at which the first layer and the second layer are at least partly in contact; and the first layer is thicker than the third layer.

20. The antenna device according to claim 19, wherein the second layer and the third layer are the same type of layer arranged on opposite sides of the first layer.
